(19) United States
(12) Patent Application Publication
(10) Pub. No.: US 2025/0111602 A1
(43) Pub. Date: Apr. 3, 2025

(54) SYSTEM, DEVICES AND/OR PROCESSES FOR IMAGE FRAME UPSCALING

(71) Applicant: Arm Limited, Cambridge (GB)

(72) Inventors: Daren Croxford, Swaffham Prior (GB); Roberto Lopez Mendez, Cambridge (GB); Mina Ivanova Dimova, Great Shelford (GB); Maxim Novikov, Manchester (GB)

(21) Appl. No.: 18/478,511

(22) Filed: Sep. 29, 2023

(51) Int. Cl. G06T 15/80; G06T 3/40; G06T 5/00; G06T 7/20; G06T 7/50

(52) U.S. Cl. CPC G06T 15/80; G06T 3/4053; G06T 5/70; G06T 7/20; G06T 7/50; G06T 2207/10024; G06T 2207/20084; G06T 2207/30168

(57) ABSTRACT

Example methods, apparatuses, and/or articles of manufacture are disclosed that may be implemented, in whole or in part, using one or more computing devices to enhance a rendered image. In an implementation, a process to enhance a portion of a rendered image may be affected based, at least in part, on a shading rate applied in rendering the portion of the rendered image.

### BACKGROUND

### 1. Field

The present disclosure relates generally to systems, devices and/or processes for image upscaling.

### 2. Information

Image processing techniques applied to digital image frames is typically performed in real-time on resource-constrained computing devices. To improve computation efficiency, digital images may be downscaled by reducing resolution prior to further processing such as temporal anti-aliasing or denoising. Such downscaling may enable performing such temporal anti-aliasing or denoising with fewer computations and usage of less memory for example. Resolution of the processed images may then be restored by upscaling for further processing and/or display.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of a computing device to perform graphics processing, according to an embodiment;

FIG. 2 is an illustration of an exemplary primitive being rendered according to different shading rates, according to an embodiment;

FIG. 3 is a schematic diagram of a graphics processing pipeline in accordance with an embodiment;

FIG. 4. is a flow diagram of a process to affect a process of upscaling portions of an image frame based, at least in part, on a shading rate, according to an embodiment;

FIG. 5 is a flow diagram of a process to upscale a portions of an image frame using one or more neural networks, according to an embodiment;

FIG. 6 is a flow diagram of a process to upscale an image frame, according to an embodiment;

FIG. 7 is a schematic diagram of an example computing system in accordance with an implementation;

FIG. 8 is a schematic diagram of a neural network formed in “layers”, according to an embodiment; and

FIG. 9 is a flow diagram of an aspect of a training operation, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

In some embodiments, such as in small form factor and/or energy constrained computation environments, an availability of computing resources (e.g., processor cycles, memory, power, etc.) may be constrained. One technique to limit or reduce usage of computing resources in graphics processing may comprise use of variable rate shading (VRS). VRS may allow portions of a scene to be rendered at a higher resolution than other portions of the scene. This may be particularly advantageous in foveated rendering, where eye tracking determines where an observer is looking, such that high quality/fine granularity rendering may be limited to a fovea region, thereby limiting a number of pixels to be rendered at higher resolutions. Other regions may be rendered with coarser granularity without impacting an observer's perception of quality. Therefore, in this case the portion of the scene that is rendered at a high quality/finer granularity may be a less complex portion of the image. Nonetheless, a VRS shading rate may be selected based, at least in part, on other parameters including, for example, primitives that are at a significant distance from a camera or are moving quickly. Such primitives may potentially be shaded at a lower rate without a perceptible degradation in image quality. In other embodiments, a VRS shading rate may be based on a combination of primitive characteristics and overall screen characteristics (e.g., foveated rendering).

In other embodiments, to improve efficiency in some graphics processing rendering (e.g., employing rasterization and/or ray tracing), spatial upscaling (e.g., to increase spatial resolution) and/or temporal upscaling (e.g., generation of “in-between” frames) may be employed. Such upscaling techniques, or so-called “super sampling” may be implemented, at least in part, using machine-learning (ML) techniques. In one example implementation, Nvidia Deep Learning Super Sampling (DLSS) 2.0 may only render ⅛ of pixels in a scene while remaining ⅞ pixels are efficiently generated using an ML technique. While super sampling may reduce computational requirements for rendering pixels in a scene, it may be appreciated that ML techniques for spatial and/or temporal upscaling may nonetheless be computationally intensive. According to an embodiment, VRS rendering and spatial and/or temporal upscaling may be performed in combination to reduce computational requirements. Additionally, VRS may be implemented in rasterization as well as hybrid-raytracing/ray-tracing types of rendering.

Briefly, particular embodiments described herein are directed to processes and/or devices for rendering image frames. In a particular implementation, an image frame may be rendered while varying a shading rate over portions of the image such that pixel values of different rendered portions are rendered at different associated shading rates. Pixel values of the different rendered portions of the image frame may be applied to an input tensor of one or more trained neural networks to upscale a spatial and/or temporal resolution of the image frame. Processing of the pixel values by the one or more neural networks for the different portions the rendered image frame may be based, at least in part, on the respective associated shading rates. By affecting a process to upscale a portion of a rendered image frame based, at least in part, on a lower applied shading rate, a less computationally intensive technique may be applied to upscale the portion of the rendered image frame.

According to an embodiment, aspects of VRS rendering may be applied to a process of machine learning super sampling (MLSS) for spatially upscaling an entirety of an image frame. In one implementation, a portion of an image frame rendered at lower VRS shading rate may be upscaled using MLSS so that the resulting resolution of that portion of the image is the same as other portions rendered at a higher VRS shading rate. As such, MLSS may be selectively applied to those portions of an image rendered at a lower VRS rate.

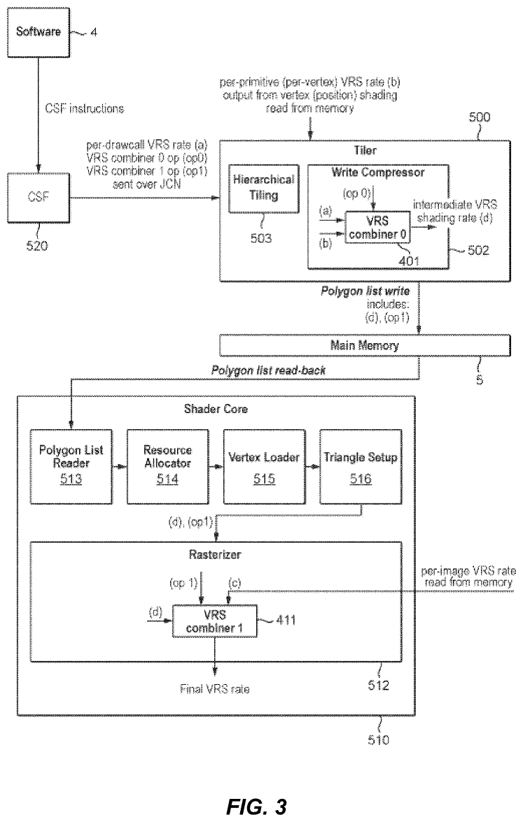

Graphics processing in an embodiment may be carried out by first splitting a scene (e.g., a 3-D model) to be displayed into a number of similar basic components or “primitives”, which primitives are then subjected to desired graphics processing operations. The graphics “primitives” may be in the form of simple polygons, such as triangles or quadrilaterals, or points or lines, such as primitive 201 in an image portion 202 shown in FIG. 2.

In one embodiment, graphics primitives may be generated by an applications program interface (API) for a graphics processing system, using graphics drawing instructions (requests) received from the application (e.g., game) that utilizes the graphics processing (render) output, for example.

A primitive may be defined by and represented as a set of vertices. Each vertex for a primitive may have associated with it a set of parameters (such as position, colour, texture and other attributes data) representing the vertex. This “vertex data” is then used, e.g., while rasterising and rendering primitive(s) to which a vertex relates in order to generate a desired render output of a graphics processing system.

For a given output, (e.g., frame to be displayed) to be generated by a graphics processing system, there may be a set of vertices defined for the output in question. Primitives to be processed for the output may then be indicated as comprising given vertices in the set of vertices for a graphics processing output being generated. In an implementation, an overall output, (e.g., frame to be generated, may be divided into smaller units of processing, referred to as “draw calls”. Each draw call may have a respective set of vertices defined for it and a set of primitives that use those vertices.

Once primitives and their vertices have been generated and defined, they can be processed by the graphics processing system, in order to generate a desired graphics processing output (render output), such as an image frame for display. This may involve determining which sampling points of an array of sampling points associated with a render output area to be processed are covered by a primitive, and then determining an appearance each sampling point should have (e.g., in terms of its colour, etc.) to represent the primitive at that sampling point. These processes may be referred to as rasterising and rendering, respectively. (The term “rasterisation” may be used to mean both primitive conversion to sample positions and rendering. However, herein “rasterisation” will be used to refer to converting primitive data to sampling point addresses only.)

A rasterizing process may determine sample positions that may be used for a primitive (e.g., (x, y) positions of sample points to be used to represent the primitive in an output, such as a scene to be displayed). This may be done using the positions of the vertices of a primitive.

A rendering process may then derive sample values (samples), such as red, green and blue (RGB) colour values and an “Alpha” (transparency) value, used to represent a primitive at sample points (i.e., “shades” each sample point). This can involve, for example, applying textures, blending sample point values, etc.

These processes may be carried out by testing sets of one, or of more than one, sampling point, and then generating for each set of sampling points found to include a sample point that is inside (covered by) a primitive in question (being tested), a discrete graphical entity usually referred to as a “fragment” on which the graphics processing operations (such as rendering) are carried out. Covered sampling points are thus, in effect, processed as fragments that may be used to render the primitive at the sampling points in question. The “fragments” are the graphical entities that pass through the rendering process (the rendering pipeline). Each fragment that is generated and processed may, e.g., represent a single sampling point or a set of plural sampling points, depending upon how the graphics processing system is configured.

Each fragment may have “fragment data”, such as colour, depth and/or transparency data, associated with it, with the fragment data for a given fragment being derived from primitive data associated with (the vertices of) the primitive to which the fragment relates. A “fragment” may therefore effectively comprise (has associated with it) a set of primitive data as interpolated to a given output space sample point or points of a primitive. It may also include per-primitive and other state data that is required to shade the primitive at the sample point (fragment position) in question. Each graphics fragment may be the same size and location as a “pixel” of the output (e.g., output frame) (since as the pixels are the singularities in the final display, there may be a one-to-one mapping between the “fragments” the graphics processor operates on (renders) and the pixels of a display). However, it can be the case that there is not a one-to-one correspondence between a fragment and a display pixel, for example where particular forms of post-processing are carried out on the rendered image prior to displaying the final image.

It may be also the case that as multiple fragments, e.g., from different overlapping primitives, at a given location may affect each other (e.g., due to transparency and/or blending), a final pixel output may depend upon plural or all fragments at an associated pixel location. Correspondingly, there may be a one-to-one correspondence between the sampling points and the pixels of a display, but more typically there may not be a one-to-one correspondence between sampling points and display pixels, as downsampling may be carried out on the rendered sample values to generate the output pixel values for displaying the final image. Similarly, where multiple sampling point values, e.g., from different overlapping primitives, at a given location affect each other (e.g., due to transparency and/or blending), a final pixel output may also depend upon plural overlapping sample values at that pixel location. Specific example embodiments described herein are directed to be integrated with rasterization-based rendering of an image frame followed by a process of upscaling based on VRS shading rates applied over portions of the image frame. Techniques described herein may also be applied to rending an image using hybrid ray-tracing and/or ray-tracing-based rendering followed by a process of upscaling based on VRS shading rates over portions of the image, and claimed subject matter is not limited to any particular rendering technique. Additionally, techniques described herein may also be applied to ray-trace and/or hybrid ray-trace denoising. For example, a process of denoising a portion of an image rendered by ray-tracing and/or hybrid ray-tracing may be controlled and/or determined by a VRS shading rate used to render that portion of the image.

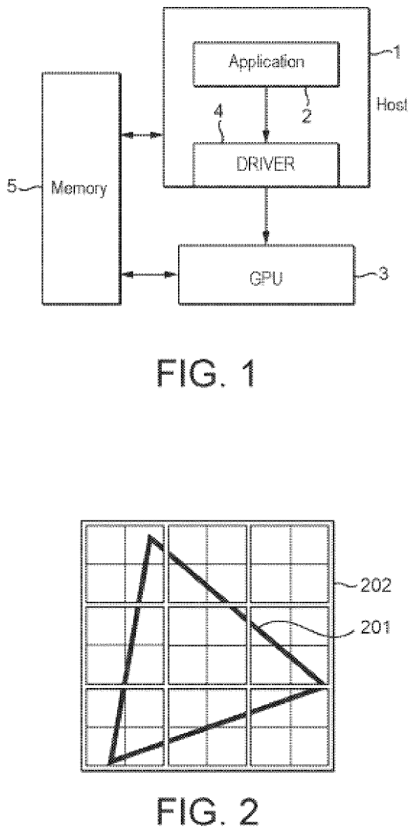

FIG. 1 shows a computer graphics processing system, comprising a host processor (CPU) 1, a graphics processing unit (GPU) 3, and a memory 5 for storing parameters required by and/or generated by the host processor 1 and graphics processor 3, according to an embodiment. While an application 2 that is executing on host processor 1 employs graphics processing from the graphics processor 3, such as a frame to be displayed, the application 2 may send appropriate commands and parameters to a driver 4 for the graphics processor 3 that is executing on host processor 1. Driver 4 may then send appropriate commands and parameters to the graphics processor 3 to cause it to generate a render output for use by application 2. In one embodiment, driver 4 may send commands and parameters to graphics processor 3 by writing to memory 5, for example. In another embodiment, host processor may directly configure states of registers in GPU 3.

Commands and parameters provided by driver 4 may include commands to render primitives for a render output to be generated by graphics processor 3, together with associated vertex parameters representing vertices to be used for primitives for the render output. Commands sent to graphics processor 3 may cause graphics processor 3 to read vertex data from memory 5, and process the read vertex parameters to generate a render output. Graphics processor 3 may then use the vertex parameters for a primitive to rasterise the primitive to one or more fragments each (potentially) applying to a region (area) of the render output. The fragments may then be rendered. A completed render output (e.g. frame) may be written in a frame buffer in memory 5, from where it may be provided for display on a display device, such as a screen or printer, for example.

A process of rendering an output, e.g. frame for display, may seek a balance between image quality and usage of processing resources. For example, “supersampling” arrangements may attempt to increase image quality by increasing the number of colours and/or pixel locations that are sampled (rendered), but this may be more processing intensive. Conversely, decreasing a number of colours and/or pixel locations that are sampled (rendered) may reduce usage of processing resources, but at the expense of reduced image quality.

A “Variable rate shading” (VRS) in this context comprises a technique that allows this balance between image quality and usage of processing resources to be varied across a render output, e.g. frame for display. In particular, VRS may allow an area of a render output, e.g., frame, so as to affect a “shading rate” so as to vary within the render output a number density and/or number of pixel locations that are sampled. Thus, in applying VRS, different a number of samples may change on a region basis. As such, in one region of a render output there may be a higher density of samples while in another region of the render output there may be a lower density of samples. To prepare a complete processed image for display, regions rendered at a lower sample rate/lower sample density may be upscaled (e.g., by copying pixels).

FIG. 3 shows graphics processing pipeline of an embodiment in more detail. As shown in FIG. 3, driver 4 sends commands and parameters for a draw call to tiling unit 500 in the form of Command Stream Frontend (CSF) instructions. Command Stream Frontend (CSF) 520 of graphics processor 3 receives these instructions, and sends appropriate commands over a Job Control Network (JCN) of the graphics processor 3 to tiling unit (“tiler”) 500 to cause tiling unit 500 to perform a “tiling” process.

In the present embodiment, tiling unit 500 may operate to distribute vertex processing tasks to a vertex shader (not shown in FIG. 3) to generate transformed vertex parameters as and when tiling unit 500 actually employs transformed vertex parameters in order to prepare primitive lists. In the present embodiment, tiling unit 500 may prepare primitive lists for different sized, “hierarchical” regions of a render output, and includes a hierarchical tiling unit 503 for this purpose. However, other, e.g., non-hierarchical, arrangements may be possible.

As shown in FIG. 3, in the present embodiment, tiling unit 500 may further includes a write compressor 502 that operates to compress primitive list information generated by the hierarchical tiling unit 503, and to write the compressed primitive list information to memory 5.

Once primitive list information has been written to memory 5, it may be read and processed by a rendering pipeline, which in the present embodiment, as shown in FIG. 3, is executed by a shader core (programmable execution unit) 510 of graphics processor 3. Graphics processor 3 may include one or more (e.g., plural) such shader cores (execution units), each of which may execute the rendering pipeline in parallel.

As shown in FIG. 3, a rendering pipeline may include primitive list reader 513, primitive setup stages including resource allocator 514, vertex loader 515, and triangle set-up unit 516, and rasteriser 512. A rendering pipeline may also include a renderer in the form of one or more fragment processing stages (not shown). Primitive list reader 513 reads appropriate primitive list(s) for a tile from memory 5 to identify primitives that are to be rendered for the tile.

Resource allocator 514 may then configure various elements of graphics processor 3 for rendering primitives that primitive list reader 513 has identified are to be rendered for a tile. For example, resource allocator 514 may appropriately configure a tile buffer of graphics processor 3 (not shown) for storing output data for a tile being rendered. Vertex loader 515 may then read appropriate processed vertex data for primitives to be rendered from memory 5, and provides primitives (i.e., their processed vertex data) to triangle set-up unit 516.

Triangle set-up unit 516 may perform primitive setup operations to setup primitives to be rendered. This may include determining, from the vertices for the primitives, edge information representing the primitive edges. Edge information for the primitives may then be passed to rasteriser 512. If rasteriser 512 receives a graphics primitive for rendering (i.e., including its edge information), it may rasterize the primitive to sampling points and generate one or more graphics fragments having appropriate positions (representing appropriate sampling positions) for rendering the primitive.

In the present embodiment, rasteriser 512 may also read in an array of “per-screen space” shading rates from memory 5, and may use this information to determine a “per-screen space” shading rate (c) for a (each) fragment.

Fragments generated by rasteriser 512 may pass to fragment processing stages (not shown) for fragment processing (rendering), and may be rendered using an output combined shading rate determined in this manner. Output data generated for a fragment may then be written appropriately to a tile buffer (not shown), and output shading rate information may be used to control this output operation. For example, in the case of a 1×1 shading rate, a single set of output data values may be written to one or more sampling points in a tile buffer corresponding to a (only) single fine pixel. In the case of a coarser shading rate, in one implementation, a single set of output data values may be written to one or more sampling points in a tile buffer corresponding to a block of plural fine pixels. In another implementation, output values may be written once into a tile buffer and potentially replicated while outputted from the tile buffer. For example, in the case of a 1×2 shading rate, a single set of output data values may be written to one or more sampling points in a tile buffer corresponding to a block of 1×2 fine pixels. Other shading rates may be handled in a corresponding manner.

Once a rendering pipeline has completed processing of a tile of render output, the rendered data for the tile is exported to memory 5 (e.g., to a frame buffer in memory 5) for storage. A next tile may then be processed by a rendering pipeline, and so on, until sufficient tiles have been processed to generate an entire render output (e.g., frame (image) to be displayed). The overall process may then be repeated for the next render output (e.g., frame), and so on. Other arrangements for the graphics processing pipeline would be possible.

Furthermore, although the above has been described with reference to a tile-based graphics processing pipeline, other forms of graphics processing pipelines, such as immediate mode graphics processing pipelines, would be possible. In the case of an immediate mode graphics processing pipeline, generation of an intermediate combined shading rate may be performed, for example, by a vertex processing stage or a primitive setup stage. While the particular implementation of FIG. 3 shows determination of VRS shading rates based on primitives, VRS shading rates in other embodiments may be determined based on other attributes such as depth.

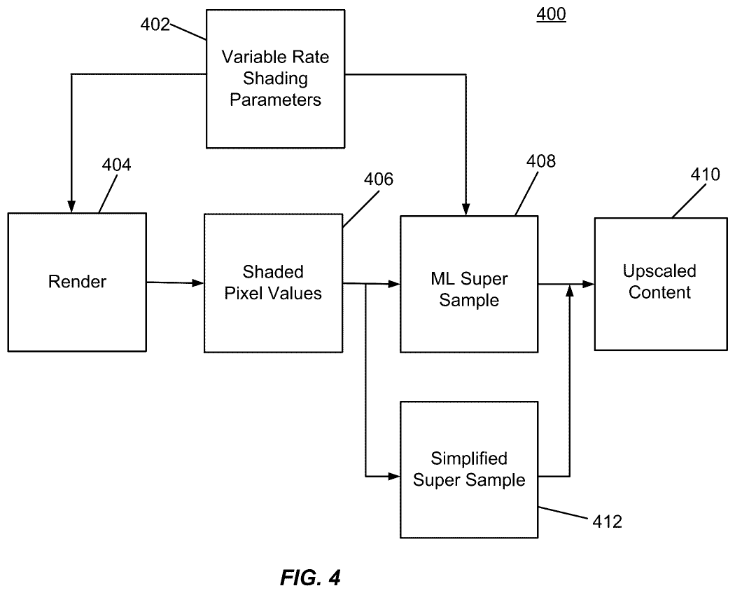

FIG. 4 is a flow diagram of a process 400 to affect a process to upscale portions of an image frame based, at least in part, on a shading rate, according to an embodiment. In one implementation, all or portions of process 400 may be executed by a GPU such as GPU 3 (FIG. 1), for example. In another implementation, specific portions of process 400 (e.g., ML Super Sample at block 408) may be executed by a separate process such as a neural processing unit (NPU). Block 402 may generate VRS parameters to be provided to block 404 for rendering portions of one or more image frames. In one particular implementation block 404 may render portions of an image frame in tiles as discussed above. Here, tiles of an image frame may comprise regions having a uniform dimension such as, for example, 32×32 pixels or 64×64 pixels, for example. It should be understood, however, that these are merely examples of dimensions of a tile, and claimed subject matter is not limited in this respect. In another particular implementation, VRS parameters from block 402 may specify multiple different shading rates for a single tile to, for example, address different levels of complexity and detail within the single tile. Block 404 may vary a shading rate for generating pixel values within the single tile according to multiple shading rates provided by block 402 for the single tile. In decreasing resolution order, multiple shading rates applied to portions of a tile may comprise 2×1, 1×2, 2×2, 1×4, 4×1, 2×4, 4×2 and 4×4 shading rates, just to provide a few examples. According to an embodiment, shaded pixel values 406 may comprise, for example, multi-color channel signal intensity values, image depth parameters or surface normal parameters, or a combination thereof, associated with pixel locations in the current image frame.

According to an embodiment, ML super sample block 408 may generate upscaled content 410 using one or more trained neural networks for at least portions of an image frame containing shaded pixel values 406. For example, all or a portion of shaded pixel values 406 may be provided to one or more input tensors of the one or more trained neural networks. In an implementation, shaded pixel values 406 provided to the one or more input tensors may comprise a portion of shaded pixel values for a single image frame to be upscaled. Neural networks at block 408 may generate predicted pixel values for an upscaled portion at an output tensor. In one implementation, ML super sample block 408 may generate upscale content as image frames having an increased spatial resolution. In another embodiment, ML super sample block 408 may generate intermediate image frames between image frames in a temporal sequence of image frames to thereby perform a temporal upscaling of shaded pixel values 406. In another implementation, block 408 may also perform denoising using an ML process (e.g., for ray tracing).

In another implementation, shaded pixel values 406 for multiple image frames in a temporal sequence of rendered image frames may be provided to an input tensor of a neural network executed at block 408 to upscale a portion of a particular image frame in the temporal sequence. For example, shaded pixel values 406 for corresponding portions of a current image frame and a previous image frame (or an accumulation of previous frames stored in a buffer) may be provided to an input tensor of a neural network executed at block 408 for generating a corresponding upscaled and/or denoised portion of the current image frame.

In another implementation, pixel values of a subsequent image frame in a temporal sequence of image frames may be rendered while varying a shading rate over portions of the subsequent image frame. Shaded pixel values of a portion of a current image frame and shaded pixel values of a corresponding portion of the subsequent image frame may be applied to an input tensor of one or more trained neural networks. Based, at least in part, on the shaded pixel values of the corresponding portions of the current and subsequent image frames, the one or more trained neural networks may generate pixel values of a corresponding portion in a temporally upscaled image frame. Processing of the pixel values of the at least one portion of the current image frame and pixel values of the at least one portion of the subsequent image frame by the one or more trained neural networks may be based, at least in part, on a highest applied shading rate. Such a highest applied shading rate may comprise, for example, a highest shading rate applied at block 404 in rendering the portion of the current image frame and/or the corresponding portion of the subsequent image frame. According to an embodiment, the current and subsequent image frames may be rendered according to a first image frame rate, and the current, subsequent and temporally upscaled image frames are in a temporal sequence of image frames according to a second image frame rate that is higher than the first image frame rate.

In another implementation, block 408 may select a trained neural network to upscale a portion of an image frame from among multiple trained neural networks based, at least in part, on a highest shading rate applied at block 404 to render the portion of the image frame. For example, shaded pixel values of the portion of the image frame may be applied to an input tensor of a trained neural network selected from among the multiple trained neural networks. Also, the highest shading rate applied at block 404 to render the shaded pixels of the portion of the image frame may also be applied to the input tensor of the trained neural network selected to process the portion of the image frame.

In another implementation, block 408 may maintain multiple buffers to provide shaded pixel values to input tensors of an associated multiple trained neural networks to provide pixel values in a spatially upscaled image frame. Individual ones of the multiple buffers may then be selected to receive different portions of shaded pixel values of an image frame rendered at block 404 based, at least in part, on shading rates applied in rendering the respective ones of the one or more different portions. In one example implementation, individual buffers/queues may be associated with one or more (e.g., a range) of shading rates that may be applied at block 404. Shaded pixel values 406 in a portion of an image frame rendered by block 404 at a particular shading rate may then be loaded to an individual buffer/queue covering and/or associated with the particular shading rate to be then processed by an associated trained neural network.

In at least one implementation of process 400, an image frame containing shaded pixel values 406 may be partitioned such that a first portion of shaded pixel values in the image frame is upscaled according to block 408 (e.g., processed by a trained ML model) and a second portion is upscaled according to a simplified (e.g., less computationally intensive) process at block 412. For example, the second portion of shaded pixel values may comprise less detail and/or variation than the first portion such that there is little to gain from application of a computationally intensive process at block 408 to upscale the second portion. Block 412 may apply a simplified upscaling process using, for example, nearest-neighbour interpolation (e.g., pixel replication), nearest neighbour-copying, bilinear interpolation and/or adaptive schemes, just to provide a few example upscaling techniques that may entail reduced computation requirements. In an example adaptive scheme, if an edge is detected (e.g., a large difference between pixel values) an edge enhancement scheme may be used while if a smooth area is detected a smoothing algorithm may be used, for example.

In another implementation, shaded pixel values 406 for different sub-portions of a tile may be upscaled differently based, at least in part, on respective VRS rates applied at block 404 to render the different sub-portions. For example, shaded pixel values of such a sub-portion rendered at a lower VRS rate (e.g., a lowest VRS rate for sub-portions of the tile) may be upscaled prior to being applied to an input tensor of a neural network (e.g., along with shaded pixel values for other sub-portions of the tile).

According to an embodiment, for a particular portion of shaded pixel values 406 to be upscaled to provide upscaled content 410, upscaling may be performed at block 408 according to a highest VRS rate applied by block 404 in rendering the particular portion of shaded pixel values 406. In one particular implementation, a portion of variable rate shading parameters 402 to be applied at block 408 may be obtained from parameters stored in a graphics pipeline buffer. In another particular implementation, a portion of variable rate shading parameters 402 to be applied at block 408 may be obtained from metadata stored in a shader core or iterator (e.g., a shader core or iterator in GPU 3 to render pixel values at block 404), or a combination thereof.

In a particular example in which a portion of shaded pixel values to be upscaled comprises a tile, for example, a super sample process applied at block 408 may be based on a highest VRS rate applied in rendering the tile at block 404. As pointed out above, shaded pixel values 406 for a particular tile to be upscaled may be provided to an input tensor of a neural network executed at block 408. In a particular implementation, such an input tensor a neural network executed at block 408 may also receive a value of a highest VRS shading rate applied in rendering the tile at block 404.

In another embodiment, an upscaling process at either block 408 or 412 may be selected for application to a portion of shaded pixel values 406 in an image frame based, at least part, on a highest VRS rate used to render the portion at block 404 (e.g., where the VRS rate may vary over the portion of shaded pixel values in the image frame). For example, application of an upscaling process at block 408 may be limited to portions of shaded pixel values 406 for which a highest VRS rate applied at block 404 exceeds a threshold VRS rate. Upscaling process at block 412 may then be applied to portions of shaded pixel values 406 for which a highest VRS applied at block 404 does not exceed the threshold VRS rate. It should be understood, however, that this is merely an example of how a process may be selected for upscaling a particular portion of shaded pixel values in an image frame, and claimed subject matter is not limited in this respect.

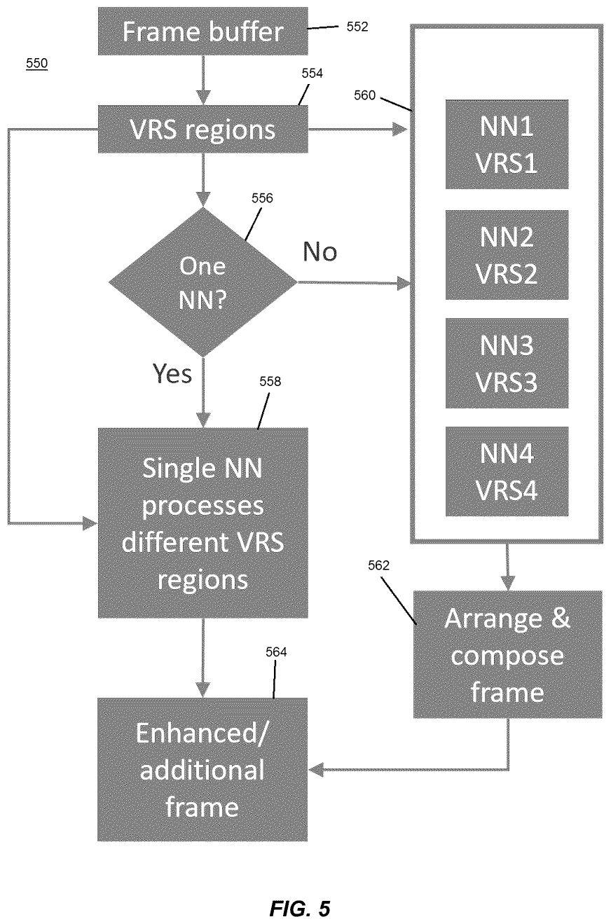

According to an embodiment, block 408 may be implemented at least in part according to process 550 shown in FIG. 5. In a particular implementation, process 550 may, at least in part, be by executed by and/or implemented on GPU 3 (FIG. 1). A rendered image frame may be stored in frame buffer 552. As discussed above, the image frame stored in frame buffer 552 may be partitioned into VRS regions in which different shading rates are applied using VRS techniques. Such VRS regions may comprise, for example, tiles as discussed above. For example, a tile in an image frame stored in frame buffer 552 (e.g., formed in memory 5, FIG. 1) forming a VRS region at block 554 may be categorized based, at least in part, on a highest VRS rate applied in rendering the tile.

According to an embodiment, process 550 may be adaptable and/or scalable according to an availability of a single neural network to be applied in upscaling all VRS regions in block 554 or an availability of multiple neural networks. If only a single neural network is available, operation 556 may select processing at block 558 where an input tensor of the single neural network is to receive for each VRS region pixel values in the VRS region and the highest shading rate applied in rendering the VRS region. As pointed out above, a single neural network at processing of block 558 may adapt, scale and/or throttle a process of upscaling of pixel values in a region based, at least in part, on the highest shading rate applied in shading the region (e.g., provided in the input tensor).

If multiple neural networks are available to upscale different VRS regions in block 554 (e.g., as determined at diamond 556), any one of multiple neural networks (e.g., neural networks NN1, NN2, NN3 or NN4) may be selected to upscale a VRS region. According to an embodiment, neural networks NN1, NN2, NN3 or NN4 may be configured to upscale VRS regions rendered according to shading rate levels VRS1, VRS2, VRS3 or VRS4, respectively. For example, tiles rendered at a highest shading rate level VRS1 may be upscaled by execution of NN1. Similarly, tiles rendered at a shading rate level VRS2 may be upscaled by execution of NN2. Likewise, tiles rendered at a shading rate level VRS3 may be upscaled by execution of NN3. Also, tiles rendered at a shading rate level VRS4 may be upscaled by execution of NN4.

In one implementation, shading rate level VRS1, VRS2, VRS3 or VRS4 may define a range of highest shading rates applied in rendering a region of an image frame. For example, shading rate level VRS1 may include highest shading rates 2×1 and 1×2, shading rate level VRS2 may include highest shading rates 2×2, 1×4 and 4×1, shading rate level VRS3 may include highest shading rates 2×4 and 4×2, and shading rate level VRS4 may include highest shading rate 4×4. By mapping each applicable highest VRS shading rates to one of four shading rate levels from among shading rate levels VRS1, VRS2, VRS3 and VRS4, a technique for upscaling any particular tile (e.g., by application of NN1, NN2, NN3 or NN4) may be specified in metadata with only two bits.

According to an embodiment, VRS regions in block 554 rendered at a like highest shading rate (e.g., associated with the same shading rate level VRS1, VRS2, VRS3 or VRS4) may be batched for upscaling at the same neural network from among neural networks NN1, NN2, NN3 and NN4. For example, pixel values of a tile making up an image frame in frame buffer 552 may be placed in a buffer/queue for an input tensor of an associated neural network (from among networks NN1, NN2, NN3 and NN4) based on a highest shading rate applied in rendering the tile. With pixel values of tiles loaded to buffers/queues of input tensors of associated neural networks, neural networks NN1, NN2, NN3 and NN4 may execute concurrently to process/upscale pixel values from tiles in respective buffers/queues. Upscaled pixel values at output tensors of neural networks NN1, NN2, NN3 and NN4 may be assembled (e.g., according to stored metadata) at block 562 to provide an upscaled image frame 564.

According to an embodiment, each of neural networks NN1, NN2, NN3 and NN4 may be constructed to vary in robustness and computational intensity. Each of NN1, NN2, NN3 and NN4 may be separately trained on portions of images rendered at shading rates on associated shading rate levels. In one implementation, NN1, NN2, NN3 and/or NN4 may be trained on input image frames rendered at appropriate shading rates while an expected output may be rendered at a higher resolution for a particular region. In another implementation, NN1, NN2, NN3 and/or NN4 may be trained for a specific VRS and/or group of VRs so as to optimize for accuracy and memory utilization. For example, shading rates may vary, such as descend from VRS1 being the highest shading rate level to VRS4 being the lowest shading rate level. As such, neural network NN1 (for processing regions rendered by highest shading rate VRS1) may perform the most robust upscaling operation with the greatest computational intensity. Conversely, neural network NN4 (for processing regions rendered by lowest shading rate VRS4) may perform the least robust upscaling with the lowest computational intensity. Thus, tiles rendered at a shading rate of VRS4 may be upscaled with sufficient accuracy using NN4 without overprocessing using the more computationally intensive NN1, NN2 or NN3. By reducing computation to upscale portions rendered at a lower resolution, substantial energy savings may be achieved. Compared to upscaling assuming a highest shading rate, altering an upscaling process for regions shaded at a lower rate may yield substantial energy/power savings.

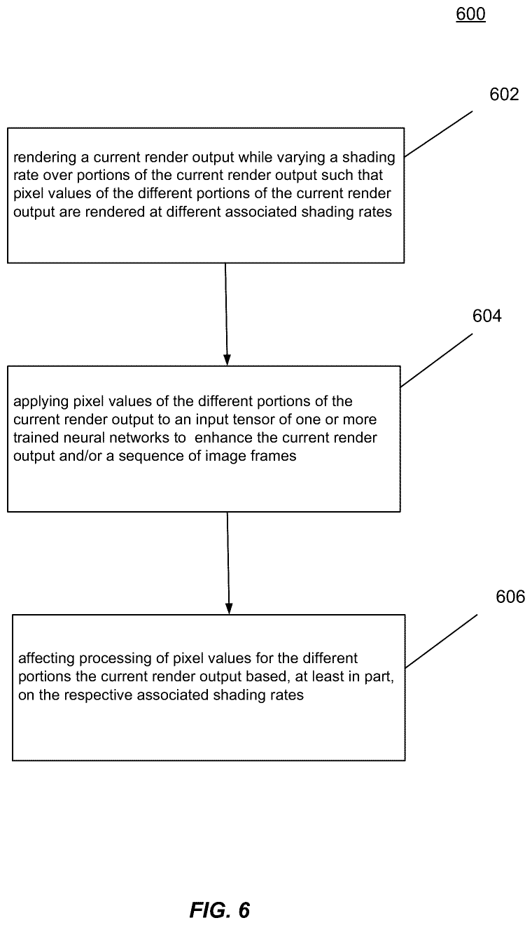

FIG. 6 is a flow diagram of a process to enhance an image frame, according to an embodiment. Block 602 may comprise generating a render output such as rendering an image frame. Such a render output may comprise pixel values such as, for example, multi-color channel signal intensity values, image depth parameters or surface normal parameters, or a combination thereof, associated with pixel locations in the rendered image frame. Block 602 may render a render output (such as an image frame rendered at block 404 (FIG. 4) and/or an image frame stored in frame buffer 522, FIG. 5) by varying an applied shading rate over portions of the image frame. For example, a render output may be rendered according to one or more shading rates in a VRS rendering process.

Block 604 may comprise processing pixel values of a render output rendered at block 602 to enhance the render output and/or enhance a sequence of image frames. In one implementation, block 604 may apply pixel values (and potentially other parameters such as image depth parameters or surface normal parameters) to an input tensor of one or more neural networks to provide a spatially upscaled version of the render output and/or denoised version of the render output. In another implementation, block 604 may apply pixel values (and potentially other parameters such as image depth parameters or surface normal parameters) to an input tensor of one or more neural networks to generate an image frame in a temporally upscaled sequence of image frames.

In one embodiment, pixel values of some portions of the render output rendered at block 602 may be applied to such an input tensor of one or more neural networks at block 604 while other portions of the render output may be enhanced using a reduced processing technique (e.g., at block 412). If an enhancement to be applied at block 604 is a spatial upscaling of the render output, such reduced processing techniques may include, for example, nearest-neighbour interpolation (e.g., pixel replication), nearest neighbour-copying, bilinear interpolation and/or adaptive schemes, just to provide a few example upscaling techniques that may entail reduced processing requirements. In another embodiment, the one or more neural networks may execute to provide values in an output tensor as pixel values of a spatially upscaled image frame. In another embodiment, render output rendered at block 602 may comprise a current image frame in a temporal sequence of image frames. Here, the one or more neural networks may execute to provide values in an output tensor as pixel values of an additional image frame in the temporal sequence of image frames, for example.

In another embodiment, block 602 may render multiple render outputs corresponding to image frames in a temporal sequence of image frames (e.g., each render output corresponding to an image frame in the temporal sequence of image frames). In an implementation, block 602 may vary shading rates over portions of some or all of the multiple render outputs. Here, block 606 may further affect processing of pixel values for a portion of a render output generated at block 602 to enhance the render output and/or sequence of image frames further based, at least in part, on shading rates applied in rendering corresponding portions of two or more of the multiple render outputs. For example, different shading rates applied in the same corresponding regions of two or more of the multiple render outputs may be used to affect a process to enhance a portion of a render output and/or sequence of image frames at block 604. In one example application, block 604 may comprise generation of pixel values of a corresponding portion (e.g., in a corresponding image region) in a temporally upscaled image frame. Block 606 may then comprise affecting generation of the pixel values of the corresponding portion in the temporally upscaled image frame based, at least in part, on shading rates applied in rendering corresponding portions of (e.g., the same corresponding region in) two or more render outputs rendered at block 602.

In one implementation, the different shading rates applied in the same corresponding regions of two or more of the multiple render outputs may be provided to an input tensor of the one or more neural networks that are to enhance to a render output and/or sequence of image frames at block 604. In another implementation, the different shading rates applied in the same corresponding regions of two or more of the multiple render outputs may be used for selection of a neural network (e.g., from among multiple neural networks) that is to impart enhancement to the same corresponding region in a render output and/or sequence of image frames at block 604. For example, a quality metric may be computed based, at least in part, on the different shading rates applied in the same corresponding regions of two or more of the multiple render outputs. The quality metric may then be used to select a neural network (e.g., from among multiple neural networks) that is to impart enhancement to the same corresponding region in a render output and/or sequence of image frames at block 604.

Block 606 may comprise altering processing applied to a portion of a render output at block 604 based, at least in part, on a shading rate applied in rendering the portion of the image frame. In one example, block 606 may comprise altering processing of a single neural network at block 558 (FIG. 5) by providing to an input tensor a highest shading rate applied in rendering a portion of an image frame. In another example, block 606 may comprise selection of a neural network to upscale the portion of the image frame from among multiple available neural networks (e.g., from among neural networks NN1, NN2, NN3 and NN4) based, at least in part, on a highest shading rate applied in rendering the portion of the image frame.

According to an embodiment, block 606 may comprise affecting processing of pixel values for a portion of a render output rendered at block 602 based, at least in part, on a highest shading rate applied in rendering the portion of the render output. In a particular implementation, block 606 may comprise obtaining a highest shading rate from metadata stored in a shader core or iterator, or a combination thereof, and applying the obtained highest shading rate to an input tensor of a trained neural network that is to upscale a portion of a rendered image frame.

According to an embodiment, block 602 may render a current image frame in a temporal sequence of image frames, and block 604 may further comprise applying parameters (e.g., pixel values) of one or more previous image frames to an input tensor of one or more neural networks. In a particular implementation, motion vectors or optical flow parameters derived from the one or more previous image frames, or a combination thereof, may also be applied to the input tensor of the one or more neural networks to upscale a spatial resolution of the current image frame.

In an embodiment to temporally upscale a temporal sequence of image frames, block 602 may render a current image frame in the temporal sequence and a subsequent image frame in the temporal sequence may be rendered while varying a shading rate over portions of the subsequent image frame. Block 604 may apply pixel values of at least one portion of the current image frame and pixel values of a corresponding at least one portion of the subsequent image frame to an input tensor of one of the one or more trained neural networks. The one or more trained neural networks may then be executed to provide pixel values of a corresponding portion in a temporally upscaled image frame in an output tensor. Block 606 may then affect processing of the pixel values of the at least one portion of the current image frame and the at least one portion of the subsequent image frame based, at least in part, on a highest shading rate applied in rendering the at least one portion of the current image frame.

Aspects of GPU 3 (FIG. 1), process 400 (FIG. 4) the graphics processing pipeline shown in FIG. 3 and process 550 (FIG. 5) as described herein in particular examples, may be formed in whole or in part by and/or expressed in transistors and/or lower metal interconnects (not shown) in processes (e.g., front end-of-line and/or back-end-of-line processes) such as processes to form complementary metal oxide semiconductor (CMOS) circuitry. The various blocks, neural networks, and other elements disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

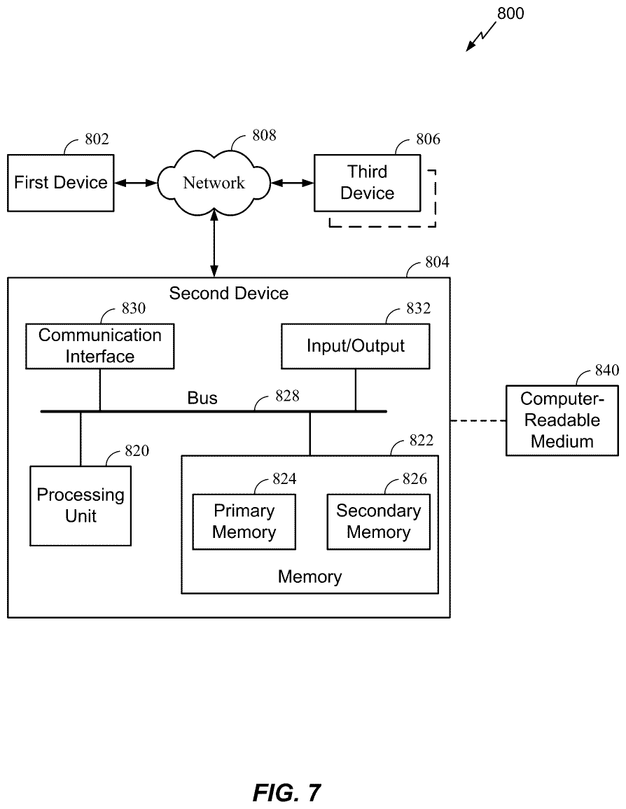

In one example embodiment, as shown in FIG. 7, a system embodiment may comprise a local network (e.g., device 804 and medium 840) and/or another type of network, such as a computing and/or communications network. For purposes of illustration, therefore, FIG. 7 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 7 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU) and/or neural network processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112(f) so that it is specifically intended that 35 USC § 112(f) not be implicated by use of the term “computing device,” “processor,” “processing unit,” “processing circuit” and/or similar terms; however, if it is determined, for some reason not immediately apparent, that the foregoing understanding cannot stand and that 35 USC § 112(f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 4, 5 and 6, and in the text associated with the foregoing figure(s) of the present patent application.

Referring now to FIG. 7, in an embodiment, first and third devices 802 and 806 may be capable of rendering a graphical user interface (GUI) for a network device and/or a computing device, for example, so that a user-operator may engage in system use. Device 804 may potentially serve a similar function in this illustration. Likewise, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 828, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 804, as depicted in FIG. 7, is merely one example, and claimed subject matter is not limited in scope to this particular example. FIG. 7 may further comprise a communication interface 830 which may comprise circuitry and/or devices to facilitate transmission of messages between second device 804 and first device 802 and/or third device 806 in a physical transmission medium over network 808 using one or more network communication techniques identified herein, for example. In a particular implementation, communication interface 830 may comprise a transmitter device including devices and/or circuitry to modulate a physical signal in physical transmission medium according to a particular communication format based, at least in part, on a message that is intended for receipt by one or more recipient devices. Similarly, communication interface 830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global navigation satellite system (GNSS) receiver and/or other location-identifying type capability, and/or a display with a higher degree of functionality, such as a touch-sensitive color 5D or 3D display, for example.

In FIG. 7, computing device 802 may provide one or more sources of executable computer instructions in the form physical states and/or signals (e.g., stored in memory states), for example. Computing device 802 may communicate with computing device 804 by way of a network connection, such as via network 808, for example. As previously mentioned, a connection, while physical, may not necessarily be tangible. Although computing device 804 of FIG. 7 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and be able to generate signals to be communicated via a network, for example, as previously described. Generated signals may also be stored in memory, also previously suggested.

Memory 822 may store electronic files and/or electronic documents, such as relating to one or more users, and may also comprise a computer-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 7, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, digital signal processors (DSPs), graphics processing units (GPUs), neural network processing units (NPUs), programmable logic devices, field programmable gate arrays, the like, or any combination thereof. For example, processor 820 may implement host processor 1 and/or GPU 3 (FIG. 1). In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 7 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

According to an embodiment, a neural network may comprise a graph comprising nodes to model neurons in a brain. In this context, a “neural network” as referred to herein means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights and/or numerical coefficients associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

According to an embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

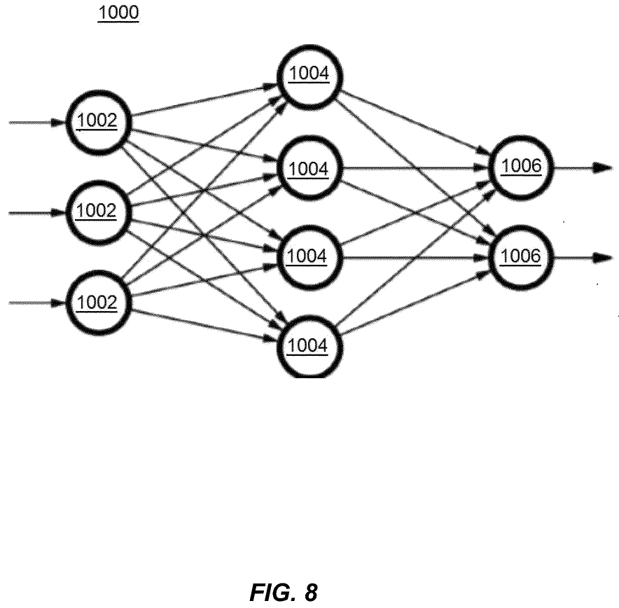

FIG. 8 is a schematic diagram of a neural network 1000 formed in “layers” in which an initial layer is formed by nodes 1002 and a final layer is formed by nodes 1006. One more features of neural network 1000 may be used to implement a neural network to execute upsampling at block 408 (FIG. 4) and/or implement NN1, NN2, NN3 and/or NN4 (FIG. 5), for example. Neural network (NN) 1000 may include an intermediate layer formed by nodes 1004. Edges shown between nodes 1002 and 1004 illustrate signal flow from an initial layer to an intermediate layer. Likewise, edges shown between nodes 1004 and 1006 illustrate signal flow from an intermediate layer to a final layer. While neural network 1000 shows a single intermediate layer formed by nodes 1004, it should be understood that other implementations of a neural network may include multiple intermediate layers formed between an initial layer and a final layer.

According to an embodiment, a node 1002, 1004 and/or 1006 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” or “input tensor” as referred to herein means an expression of one or more activation input values according to a particular structure, dimension and/or format. Likewise in this context, an “activation output tensor” or “output tensor” as referred to herein means an expression of one or more activation output values according to a particular structure, dimension and/or format.

According to an embodiment, neural network 1000 may be characterized as having a particular structure or topology based on, for example. a number of layers, number of nodes in each layers, activation functions implemented at each node, quantization of weights and quantization of input/output activations. Neural network 1000 may be further characterized by weights to be assigned to nodes to affect activation functions at respective nodes. During execution, neural network 1000 may be characterized as having a particular state or “intermediate state” determined based on values/signals computed by nodes (e.g., as activation tensor values to be provided to nodes in a subsequent layer of nodes and/or an output tensor).

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing (e.g., medical records processing), brain-computer interfaces, financial time series, just to provide a few examples.

Another class of layered neural network may comprise a recurrent neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

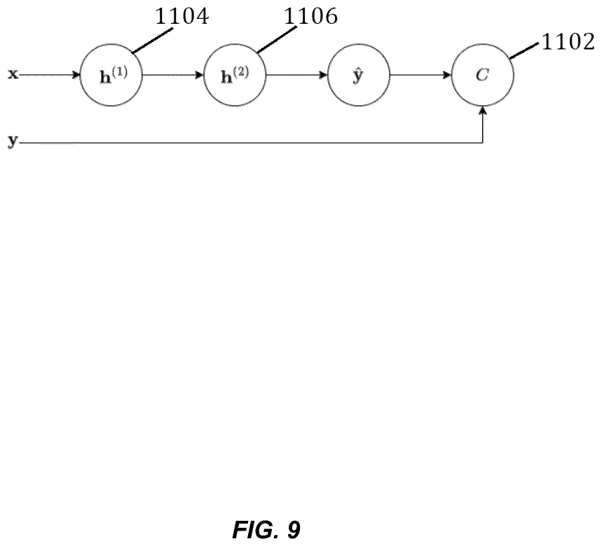

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques. “Backpropagation,” as referred to herein, is to mean a process of fitting parameters of a trained inference model such a model comprising one or more neural networks. In fitting parameters of a neural network, for example, backpropagation is to compute a gradient of a loss function with respect to the weights of the neural network. Based on such a computed gradient of a loss function, weights may be updated so as to minimize and/or reduce such a loss function. In one particular implementation, a gradient descent of a loss function, or variants such as stochastic gradient descent of a loss function, may be used. In training parameters of a neural network, backpropagation may comprise computing a gradient of a loss function with respect to individual weights by the chain rule, computing a gradient one layer at a time, iterating backward from the last layer to avoid redundant calculations of intermediate terms in the chain rule, for example. It should be understood, however, that this is merely an example of how a process of backpropagation may be applied, and claimed subject matter is not limited in this respect. In particular implementations, backpropagation may be used to iteratively update neural network weights to be associated with nodes and/or edges of a neural network based, at least in part on “training sets.” Such training sets may include training measurements and/or observations to be supplied as input values that are paired with “ground truth” observations. Based on a comparison of such ground truth observations and associated prediction values generated based on such input values in a training process, weights may be updated according to a loss function using backpropagation. FIG. 9 is a flow diagram of an aspect of a training operation employing backpropagation to train parameters for a feedforward neural network, according to an embodiment. It should be understood, however, that this is merely an example of a type of neural network that may be trained using backpropagation, and that similar backpropagation techniques may be applied to train parameters of other types of neural networks without deviating from claimed subject matter. Training sets may be provided to such a training operation as pairs of vectors (x,y) where x is an input vector and y is a corresponding ground truth label to apply a supervised learning technique. It should be understood that unsupervised learning techniques may be used without loss of generality. Input vector x may be provided as an input tensor to a first hidden layer 1104 to produce an output vector h⁽¹⁾, which is provided as an input to a second hidden layer 1106 to provide an output vector h⁽²⁾. An inference and/or prediction ŷ may be computed based, at least in part, on the output vector h⁽²⁾. A loss function C may be computed at 1102 based, at least in part, on inference and/or prediction ŷ and ground truth label y.

In the particular embodiment of FIG. 9, inference and/or prediction ŷ, and output vectors h⁽¹⁾ and h⁽²⁾ may be modelled as follows:

$${h}^{( 1 )} = {g}^{( 1 )} ( {W}^{( 1 ) T} x + {b}^{( 1 )} )$$

$${h}^{( 2 )} = {g}^{( 2 )} ( {W}^{( 2 ) T} {h}^{( 1 )} + {b}^{( 2 )} )$$

$$\hat{y} ( x ) = {W}^{( 3 ) T} {h}^{( 2 )} + {b}^{( 3 )} ,$$

where:
g⁽ⁱ⁾ is an activation function applied at nodes in hidden layer i;
W⁽ⁱ⁾ is a matrix of weights such that weight Wⱼₖ⁽ⁱ⁾ is to be applied at an edge going from node j in layer i−1 to node k in hidden layer i; and
b⁽ⁱ⁾ is a bias matrix applied at hidden layer i.

In a particular implementation in which a feedforward neural network includes three or more hidden layers, computation of ŷ(x) may be generalized as follows:

$$\hat{y} ( x ) = {W}^{( N ) T} {h}^{( N - 1 )} + {b}^{( N )} .$$

Loss function C(y, ŷ) may be computed according to any one of several formulations of a loss function as described above. In a particular implementation, C(y, ŷ) may be differentiable such that

$$\frac{\partial C}{\partial {W}_{jk}^{( i )}}$$

may be determined using the chain rule and may be computed for any weight Wⱼₖ⁽ⁱ⁾. According to an embodiment, values for W⁽ⁱ⁾ may be determined iteratively for training sets (x,y) using a gradient descent technique.

One embodiment disclosed herein is directed to an article comprising: a non-transitory storage medium comprising computer-readable instructions stored thereon that are executable by one or more processors to: render a current render output while varying a shading rate over portions of the current render output such that pixel values of different portions of the current render output are rendered at different associated shading rates; apply pixel values of the different portions of the current render output to an input tensor of one or more trained neural networks to enhance the current render output and/or a sequence of image frames; and affect processing of pixel values for the different portions the current render output to enhance the current render output and/or sequence of image frames based, at least in part, on respective shading rates associated with the different portions.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
rendering a current render output while varying a shading rate over portions of the current render output such that pixel values of different portions of the current render output are rendered at different associated shading rates;
applying pixel values of the different portions of the current render output to an input tensor of one or more trained neural networks to enhance the current render output and/or a sequence of image frames; and
affecting processing of pixel values for the different portions of the current render output to enhance the current render output and/or sequence of image frames based, at least in part, on respective shading rates associated with the different portions.

2. The method of claim 1, and further comprising applying parameters of one or more previous render outputs to the input tensor.

3. The method of claim 1, and further comprising applying motion vectors or optical flow parameters derived from one or more previous image frames, or a combination thereof, to the input tensor.

4. The method of claim 1, applying pixel values of at least one portion to be processed by the one or more trained neural networks and at least one portion to be processed independently of the one or more trained neural networks.

5. The method of claim 1, wherein the pixel values comprise multi-color channel signal intensity values, image depth parameters or surface normal parameters, or a combination thereof, associated with pixel locations in the current render output.

6. The method of claim 1, wherein the affecting processing of pixel values for the different portions of the current render output comprises affecting processing of pixel values for a portion of the current render output based, at least in part, on a shading rate applied in rendering the portion of the current render output.

7. The method of claim 6, and further comprising:
obtaining the shading rate applied in rendering the portion of the current render output from metadata stored in a shader core or iterator, or a combination thereof; and
applying the obtained shading rate applied in rendering the portion of the current render output to the input tensor.

8. The method of claim 6, wherein the method further comprises:
applying at least some of the pixel values of the portion of the current render output and the shading rate applied in rendering the portion of the current render output to the input tensor, wherein the shading rate varies over the portion of the current render output; and
upscaling a sub portion of the portion of the current render output having a lowest shading rate prior to applying the pixel values of the portion of the current render output to the input tensor.

9. The method of claim 6, the method further comprising:
selecting a trained neural network from among a plurality of trained neural networks based, at least in part, on the shading rate applied in rendering the portion of the current render output; and
applying pixel values of the portion of the current render output to an input tensor of the selected trained neural network,
wherein applying pixel values of the portion of the current render output and the shading rate applied in rendering the portion of the current render output to the input tensor.

10. The method of claim 1, and further comprising:
rendering a subsequent render output while varying a shading rate over portions of the subsequent render output;
applying pixel values of at least one portion of the current render output and pixel values of a corresponding at least one portion of the subsequent render output to an input tensor of at least one of the one or more trained neural networks to generate pixel values of a corresponding portion in a temporally upscaled image frame; and
affecting processing of the pixel values of the at least one portion of the current render output and pixel values of the at least one portion of the subsequent render output by the at least one of the one or more trained neural networks based, at least in part, on a highest shading rate applied in rendering the at least one portion of the current render output.

11. The method of claim 10, wherein the current render output and the subsequent render output are rendered according to a first image frame rate, and the current, subsequent and temporally upscaled image frames are in a temporal sequence of image frames according to a second image frame rate that is higher than the first image frame rate.

12. The method of claim 1, wherein affecting the processing of the pixel values for the different portions of the current render output further comprises:
selecting from among a plurality of trained neural networks to enhance at least one of the portions of the current render output based, at least in part, on a shading rate associated with the at least one of the portions of the current render output.

13. The method of claim 1, and further comprising:
maintaining a plurality of buffers to provide pixel values to input tensors of an associated plurality of trained neural networks; and
selecting from among the plurality of buffers to load pixel values of respective ones of the one or more of different portions of the current render output based, at least in part, on shading rates applied in rendering the respective ones of the different portions,
wherein the associated plurality of trained neural networks to provide pixel values in a spatially upscaled image frame.

14. The method of claim 1, wherein the current render output and/or the sequence of image frames to be enhanced by the one or more trained neural networks at least by upscaling a spatial resolution of the current render output.

15. The method of claim 1, wherein the current render output and/or the sequence of image frames to be enhanced by the one or more trained neural networks at least by upscaling a temporal resolution of the sequence of image frames.

16. The method of claim 1, wherein the current render output and/or the sequence of image frames to be enhanced by the one or more trained neural networks at least by denoising a portion of the current render output.

17. The method of claim 1, and further comprising:
rendering one or more other rendered outputs while varying a shading rate over portions of at least one of the one or more other rendered outputs, the current render output and the one or more other rendered outputs corresponding with image frames in the sequence of image frames; and
affecting processing of pixel values for at least one of the different portions of the current render output to enhance the current render output and/or sequence of image frames further based, at least in part, on a shading rate applied in rendering a corresponding portion of the at least one of the one or more other rendered outputs.

18. The method of claim 1, and further comprising:
rendering one or more other rendered outputs while varying a shading rate over portions of at least one of the one or more other rendered outputs, the current render output and the one or more other rendered outputs corresponding with image frames in the sequence of image frames;
computing a quality metric based, at least in part, on shading rates applied in rendering corresponding portions of current rendered output and the at least one of the one or more other rendered outputs; and
affecting processing of pixel values for at least one of the different portions of the current render output to enhance the current render output and/or sequence of image frames further based, at least in part, on the computed quality metric.

19. The method of claim 1, and further comprising:
rendering one or more other rendered outputs while varying a shading rate over portions of at least one of the one or more other rendered outputs, the current render output and the other rendered outputs corresponding with image frames in the sequence of image frames; and
applying pixel values of at least one portion of the current render output and pixel values of a corresponding at least one portion of the at least one of the one or more other render outputs to an input tensor of at least one of the one or more trained neural networks to generate pixel values of a corresponding portion in a temporally upscaled image frame; and
affecting generation of the pixel values of the corresponding portion in the temporally upscaled image frame based, at least in part, on a shading rate applied in rendering the at least one portion of the current render output and a shading rate applied in rendering the corresponding at least one portion of the at least one of the other render outputs.

20. A computing device, comprising:
a memory; and
one or more processors coupled to the memory to:
render a current render output while varying a shading rate over portions of the current render output such that pixel values of different portions of the current render output are rendered at different associated shading rates;
apply pixel values of the different portions of the current render output to an input tensor of one or more trained neural networks to enhance the current render output and/or a sequence of image frames; and
affect processing of pixel values for the different portions the current render output to enhance the current render output and/or sequence of image frames based, at least in part, on respective shading rates associated with the different portions.
